(19) United States
(12) Patent Application Publication
(10) Pub. No.: US 2024/0026961 A1
(43) Pub. Date: Jan. 25, 2024

(54) STEPLESS POWER SPLIT TRANSMISSION

(71) Applicant: ZF Friedrichshafen AG, Friedrichshafen (DE)

(72) Inventors: Gerhard Milbradt, Friedrichshafen (DE); Christian Kreutle, Hergensweiler (DE); Rainer Hildebrand, Friedrichshafen (DE); Taras Bidenko, Friedrichshafen (DE); Rudolf Zentsch, Friedrichshafen (DE); Jan Baudis, Horgenzell (DE); Stefan Dirnberger, Schönau (DE); Johannes Ziegler, Uttenweiler (DE); Wiebke Breil, Kressbronn (DE); Giuseppe Muro, Friedrichshafen (DE)

(73) Assignee: ZF Friedrichshafen AG, Friedrichshafen (DE)

(21) Appl. No.: 18/353,916

(22) Filed: Jul. 18, 2023

(30) Foreign Application Priority Data
Jul. 21, 2022 (DE) 10 2022 207 434.3

(51) Int. Cl. F16H 47/04; F16H 37/08

(52) U.S. Cl. CPC F16H 47/04; F16H 37/084; F16H 2037/0866

(57) ABSTRACT

A continuously variable power-branched transmission has a shaft (4) that can be coupled to a drive motor, where the drive motor is connected to at least one variator (1). In order to obtain forward and reverse driving operation, the drive motor is coupled by way of spur gear pairs that can be engaged by means of driving direction clutches (KV, KR) to a drive output (13). The driving direction clutches (KV, KR) are arranged a distance apart.

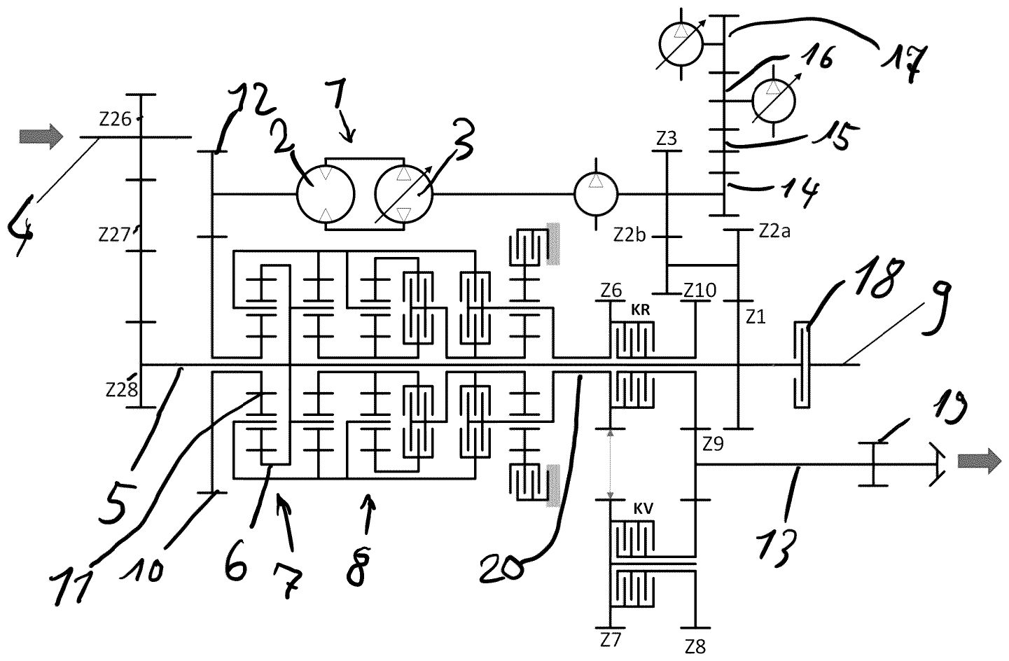

### RELATED APPLICATIONS

This application claims the benefit of and right of priority under 35 U.S.C. § 119 to German Patent Application no. 10 2022 207 434.3, filed on 21 Jul. 2022, the contents of which are incorporated herein by reference in its entirety.

### FIELD OF THE DISCLOSURE

The invention relates to a continuously variable power-branched transmission.

### BACKGROUND

A primarily coupled power-branched transmission of this type with a variator is known from DE 10 2014 220 594 A1.

In the manner described above, mechanical-hydrostatic power-split continuously variable transmissions, which are used, among other things, in agricultural machines such as towing vehicles, also known as tractors, are designed to have a several driving ranges so as to restrict the hydrostatic power component, which is characterized by reduced efficiency compared to the mechanical component in order to improve the overall efficiency of such a transmission. To improve a functionality of vehicles, driving range changes are often automated and are carried out without any traction force interruption. Besides high driving speeds for transport purposes, around 50 km/h, an agricultural machine aided by modern transmission systems should be able to be operated at a reduced motor rotation speed at high driving speeds in order to reduce fuel consumption. By virtue of their design, the transmission systems known as such are all made with defined spreads. Likewise, the structural space occupied by the power-branched transmission should be as compact as possible, since that space substantially influences the design of the agricultural machine.

### SUMMARY

Thus, the purpose of the present invention is to further improve a continuously variable power-branched transmission.

According to the invention, this objective is achieved with a continuously variable power-branched transmission having the characteristics disclosed herein.

The continuously variable power-branched transmission according to the invention is made with a transmission input shaft that can be coupled to a drive machine, which is functionally connected to a variator and can be coupled to a transmission output shaft via gearwheel pairs that can be engaged by way of driving direction clutches in order to determine forward-driving and reverse-driving operation. In the area of a change-speed transmission at least two and ideally four driving ranges can be obtained, within which the transmission ratio can be adjusted continuously by means of the variator. In addition, an auxiliary power takeoff and an option for powering a front axle are provided, wherein the latter possibility can even be arranged outside the transmission housing.

According to the invention the change-speed transmission comprises a number of planetary gearsets which can be engaged by means of clutches. Coaxially with these planetary gearsets there is arranged a summation gearset, which is also in the form of a planetary gearset. A first driving direction clutch is arranged coaxially with the change-speed transmission, while the second driving direction clutch is positioned a distance away from the first driving direction clutch.

A shaft, which is connected directly or indirectly to the input shaft of the power-branched transmission, passes through both the summation gearset and also the change-speed transmission. The shaft is functionally connected on one side to the summation gearset and on the other side functionally connected to a unit of the variator, forming the drive input for an auxiliary power takeoff.

The power-branched transmission is designed to be primarily coupled. In this context primarily coupled means that the first unit of the variator is functionally connected directly or indirectly to the input shaft of the power-branched transmission and at the same time the input shaft is functionally connected directly or indirectly to the summation gearset, and the second unit of the variator is also functionally connected directly or indirectly to the summation gearset and a shaft of the summation gearset forms the drive output.

The variator comprises a first unit and a second unit, wherein the said units can be in the form of hydraulic units, such as piston machines also known as hydrostats, or else the units can be in the form of electrical units.

The change-speed transmission is arranged a distance away from the input shaft, which latter can be connected to a drive motor. That distance is bridged by a spur gear system preferably consisting of three gearwheels in order to keep to the same rotation direction between the drive input to the spur gear system and the drive output from the spur gear system. This makes it possible to position the drive motor, which for example can be an internal combustion engine or an electric motor, a distance away from the change-speed transmission so that in the towing vehicle more structural space remains free underneath the internal combustion engine. The spur gear system is arranged in a plane, thus arranged one above the other, so that the structural length and the transmission width of the power-branched transmission are not made longer and wider. This makes it possible for the transmission and the motor to be arranged in the vehicle in such manner that the space required to achieve a smaller turning circle of the vehicle is made available. Preferably, the spur gear system is designed such that the drive input rotation speed of the spur gear system is lower than its drive output rotation speed. This improves the efficiency and reduces the torque at the drive input into the summation gearset.

The drive output shaft of the change-speed transmission drives a spur gear and at the same time part of the first driving direction clutch. This driving direction clutch is preferably the clutch for the reverse driving direction. The spur gear driven by the drive output shaft meshes with a spur gear which is functionally connected to part of the second driving direction clutch. Thus, the first and second driving direction clutches are arranged a distance apart. Preferably the transmission ratio between these spur gears is chosen such that the second driving direction clutch has a higher rotation speed than the first driving direction clutch. The second driving direction clutch is preferably designed for the forward driving direction. In that way the torque and thus the transmission capacity of the driving direction clutch for the forward direction is increased.

Another part of the first driving direction clutch is connected to a spur gear and a further part of the second driving direction clutch is functionally connected to a further spur gear. Thus, the secondary sides of the driving direction clutches are in each case functionally connected to a respective spur gear. These two spur gears mesh with a spur gear which is functionally connected to the drive output shaft of the power-branched transmission, so that the said drive output shaft can drive a rear axle of the towing vehicle.

The variator comprises two units which are functionally connected to one another, and the first unit is functionally connected to part of the summation gearset while the second unit of the variator is functionally connected by way of a spur gear stage to the input shaft in the summation gearset, which also passes through the change-speed transmission. The said spur gear stage comprises a first spur gear which is functionally connected to the input shaft of the summation gearset and also comprises a double spur gear having two spur gears which are arranged on a shaft, wherein one spur gear of the double spur gear meshes with the first spur gear. The second spur gear of the double spur gear meshes with a spur gear functionally connected to a shaft which drives a unit of the variator. Thanks to the use of the double spur gear, components can be displaced past the driving direction clutches. The structural space above the double spur gear left free in that way can then be used for example for a spur gear arrangement for driving several hydraulic pumps, without increasing the overall length of the power-branched transmission.

### BRIEF DESCRIPTION OF THE DRAWING

Further features emerge from the description of the sole figure.

### DETAILED DESCRIPTION

The sole figure shows a primarily coupled power-branched transmission with a continuously variable power branch which comprises a variator 1 for the continuous variation of a gear ratio of the power-branched transmission. The variator 1 comprises a unit 2 and a unit 3, wherein the units 2 and 3 can be in the form of hydraulic units, so-termed hydrostats, or electrical units. A drive motor (not shown), for example an internal combustion engine or an electric motor, can be connected to the shaft 4 in order to drive the shaft 4. The shaft 4 is connected rotationally fixed to the spur gear Z27. The spur gear Z27 meshes with the spur gear Z28. The spur gear Z28 is connected rotationally fixed to the drive input shaft 5. In that way the drive motor is arranged a distance away from the input shaft 5. The input shaft 5 is connected rotationally fixed to a ring gear 6 of the summation gearset 7. However, the input shaft 5 also passes through the summation gearset 7 and the change-speed transmission 8 and is connected rotationally fixed to the spur gear Z1, so forming the drive input for an auxiliary power takeoff 9.

The summation gearset 7 is in the form of a planetary gearset and is arranged coaxially with the change-speed transmission 8. The auxiliary power takeoff 9 is arranged opposite the shaft 4, thus on the other side of the power-branched transmission. The change-speed transmission 8 comprises a number of planetary gearsets and shifting clutches, by means of which several driving ranges can be engaged. Preferably, four driving ranges can be engaged.

The summation gearset 7 comprises a sun gear 11 which is connected rotationally fixed to a spur gear 10. The spur gear 10 meshes with the spur gear 12. The spur gear 12 is connected rotationally fixed by way of a shaft to the unit 2. The driving direction clutch KR is arranged coaxially with the change-speed transmission and is connected on one side rotationally fixed to a component with the spur gear Z6 and on the other side to a component with the spur gear Z10. The spur gear Z6 meshes with the spur gear Z27, which is connected rotationally fixed to part of the driving direction clutch KV. Thus, the driving direction clutch KV is arranged a distance away from and not coaxially with the driving direction clutch KR. A component of the driving direction clutch KV is connected rotationally fixed to the spur gear Z8. The spur gear Z8 meshes with the spur gear Z9. However, the spur gear Z9 also meshes with the spur gear Z10. The spur gear Z9 is connected to the drive output 13, which for example can drive a rear axle and/or a front axle of a towing vehicle. If the driving direction clutch KV is actuated in the closing direction and the driving direction clutch KV is actuated in the opening direction, then the shaft 4 drives the drive output 13 by way of the power-branched transmission in a first driving direction. Since the gear ratios of the spur gears Z6 and Z7 are different, the driving direction clutch KV or KR can be acted upon with more torque or less torque with the same output power, depending on the gear ratio chosen.

The shaft 5 is connected rotationally fixed to the spur gear Z1, which meshes with the spur gear Z2b of the double spur gear. The spur gear Z2a is connected rotationally fixed to the spur gear Z2b of the double spur gear. The spur gear Z10 is arranged between the spur gear Z2a and the spur gear Z2b.

The spur gear Z2b meshes with the spur gear Z3. The spur gear Z3 is connected rotationally fixed to the unit 3 of the variator 1.

The spur gear Z3 is connected rotationally fixed to the spur gear 14. The spur gear 14 meshes with the spur gear 15. The spur gear 15 meshes with the spur gear 16. The spur gear 16 meshes with the spur gear 17. The spur gear 17 is connected rotationally fixed to a pump and the spur gear 16 is connected rotationally fixed to a pump. By means of the clutch 18 the auxiliary power takeoff 9 can be engaged. By way of the spur gear 19 a further drive axle of the vehicle can be driven.

### INDEXES

1 Variator
2 Unit
3 Unit
4 Shaft
5 Drive input shaft
6 Ring gear
7 Summation gearset
8 Change-speed transmission
9 Auxiliary power takeoff
10 Spur gear
11 Sun gear
12 Spur gear
13 Drive output
14 Spur gear
15 Spur gear
16 Spur gear
17 Spur gear
18 Clutch
19 Spur gear
20 Drive output shaft
Z1 Spur gear
Z2a Spur gear
Z2b Spur gear
Z3 Spur gear
Z6 Spur gear
Z7 Spur gear
Z8 Spur gear
Z9 Spur gear
Z10 Spur gear
Z26 Spur gear
Z27 Spur gear
Z28 Spur gear
KV Driving direction clutch
KR Driving direction clutch

1. A continuously variable power-branched transmission, comprising:
at least one variator (1) connected to a drive machine;
gearwheel pairs configured to be engaged by a first driving direction clutch (KV) and a second driving direction clutch (KR);
a shaft (4) configured to be coupled to the drive machine and to a drive output (13) in order to produce forward and reverse driving operation by way of the gearwheel pairs, wherein, in the area of a change-speed transmission (8) at least two driving ranges can be obtained, within which ranges a gear ratio can be adjusted continuously by means of the at least one variator (1), and wherein an auxiliary power takeoff (9) is provided having a summation gearset (7) which is functionally connected to a drive input shaft (5);
wherein the first driving direction clutch (KR) arranged coaxially with the change-speed transmission (8) and the second driving direction clutch (KV) is arranged a distance away from the first driving direction clutch (KR), and the drive input shaft (5) passes through one of the first or second driving direction clutches.

2. The continuously variable power-branched transmission according to claim 1, wherein a first gear ratio obtained with the first driving direction clutch (KR) is different from a second gear ration obtained with the second driving direction clutch (KV).

3. The continuously variable power-branched transmission according to claim 1, wherein the drive input shaft (5) is functionally connected with the at least one variator (1) by way of spur gears (Z1, Z2a, Z2b, Z3).

4. The continuously variable power-branched transmission according to claim 1, wherein the drive input shaft (5) is configured to drive hydraulic pumps by way of spur gears (Z1, Z2a, Z2b, Z3, 14, 15, 16, 17).

5. The continuously variable power-branched transmission according to claim 3, wherein at least two spur gears (Z2a, Z2b) are in the form of a double spur gear.

6. The continuously variable power-branched transmission according to claim 5, wherein a spur gear (Z10) which is functionally connected to the drive output (13), is arranged between the spur gears (Z2a, Z2b) of the double spur gear.

7. The continuously variable power-branched transmission according to claim 1, wherein the shaft (4) is functionally connected by way of a spur gear stage with spur gears (Z26, Z27, Z28) to the drive input shaft (5).

8. The continuously variable power-branched transmission according to claim 1, wherein the summation gearset (7) and the change-speed transmission (8) are arranged coaxially.

9. The continuously variable power-branched transmission according to claim 1, wherein the power-branched transmission is configured as a primarily coupled transmission.

10. The continuously variable power-branched transmission according to claim 1, wherein the at least one variator (1) comprises units (2, 3) which are in the form of hydraulic or electrical units and are functionally connected with one another.

11. The continuously variable power-branched transmission according to claim 4, wherein at least two spur gears (Z2a, Z2b) are in the form of a double spur gear.

12. The continuously variable power-branched transmission according to claim 11, wherein a spur gear (Z10) which is functionally connected to the drive output (13), is arranged between the spur gears (Z2a, Z2b) of the double spur gear.
